(19) United States
(12) Patent Application Publication
(10) Pub. No.: US 2025/0054940 A1
(43) Pub. Date: Feb. 13, 2025

(54) ROLLING APPARATUS AND ROLLING METHOD FOR ELECTRODE SHEET

(71) Applicant: Prime Planet Energy & Solutions, Inc., Tokyo (JP)

(72) Inventor: Yoshikazu KAWAI, Akashi-shi (JP)

(21) Appl. No.: 18/791,428

(22) Filed: Aug. 1, 2024

(30) Foreign Application Priority Data
Aug. 7, 2023 (JP) 2023-128385

(51) Int. Cl. H01M 4/04; H01M 10/04

(52) U.S. Cl. CPC H01M 4/0435; H01M 4/0404; H01M 10/0404

(57) ABSTRACT

A rolling apparatus includes a transportation device transporting an electrode sheet along a predefined transportation path; a pair of press rolls located on the transportation path and pressing an active material layer of the electrode sheet; and a correction roll located upstream or downstream with respect to the pair of press rolls. The correction roll includes at least one short-diameter portion each provided at a position corresponding to the active material layer in the width direction of the electrode sheet, and a plurality of long-diameter portions each having an outer diameter longer than an outer diameter of the short-diameter portion, non-formation portions of the electrode sheet being respectively wound along the plurality of long-diameter portions. The plurality of long-diameter portions includes a first long-diameter portion, and a second long-diameter portion, the outer diameter of which is longer than the outer diameter of the first long-diameter portion.

### CROSS REFERENCE TO RELATED APPLICATION

This application claims the benefit of priority to Japanese Patent Application No. 2023-128385 filed on Aug. 7, 2023. The entire contents of this application are hereby incorporated by reference herein.

### BACKGROUND

The present invention relates to a rolling apparatus and a rolling method for an electrode sheet.

For example, Japanese Patent No. 6021508 discloses a device pressing a band-like electrode plate (electrode sheet) including an active material-containing layer that includes an active material-containing slurry applied to a band-like current collector and a current collector exposed portion with no active material-containing layer. The device described in Japanese Patent No. 6021508 includes a press roll pressing the active material-containing layer and a guide roller acting also as a curved portion correction device. Japanese Patent No. 6021508 describes the following. The pressing pressure of the press roll is mainly applied to the active material-containing layer and is not applied to the current collector exposed portion almost at all. Therefore, a stretched length by which the current collector exposed portion is stretched is shorter than a stretched length by which the current collector as an underlying layer of the active material-containing layer is stretched. As a result, the band-like electrode plate is strained or warped.

The guide roller described in Japanese Patent No. 6021508 includes a protruding portion in contact with the current collector exposed portion and a recessed portion facing the active material-containing layer. Japanese Patent No. 6021508 describes the following. With this configuration, a tensile force applied in a transportation direction of the band-like electrode plate may be concentrated on the current collector exposed portion. As a result, the current collector exposed portion may be stretched, and thus the strain or the warp caused to the band-like electrode plate may be corrected.

### SUMMARY

According to the knowledge of the present inventor, in the case of an electrode sheet in which a plurality of non-formation portions with no active material layer are located in a width direction thereof, even if the non-formation portions are stretched by a stepped roll as described in Japanese Patent No. 6021508, the electrode sheet may possibly be strained due to a difference in the stretched length among the plurality of non-formation portions. Therefore, the present invention has an object of suppressing the difference in the stretched length among the plurality of non-formation portions.

A rolling apparatus rolling an electrode sheet disclosed herein rolls an electrode sheet including a band-like current collecting foil and at least one active material layer, the current collecting foil including at least two non-formation portions, the at least one active material layer and the at least two non-formation portions being located alternately in a width direction of the current collecting foil, and the at least two non-formation portions being located at both of two ends of the current collecting foil in the width direction. The rolling apparatus includes a transportation device transporting the electrode sheet in a longitudinal direction thereof along a predefined transportation path; a pair of press rolls located on the transportation path along which the electrode sheet is transported by the transportation device, the pair of press rolls sandwiching the electrode sheet to press the active material layer; and a correction roll located upstream or downstream with respect to the pair of press rolls in the transportation path and extending in the width direction of the electrode sheet. The correction roll includes at least one short-diameter portion each provided at a position corresponding to the at least one active material layer in the width direction of the electrode sheet, and a plurality of long-diameter portions each having an outer diameter longer than an outer diameter of the short-diameter portion, the at least two non-formation portions being respectively wound along the plurality of long-diameter portions. The plurality of long-diameter portions includes a first long-diameter portion, and a second long-diameter portion, the outer diameter of which is longer than the outer diameter of the first long-diameter portion.

According to the above-described rolling apparatus for the electrode sheet, the plurality of long-diameter portions included in the correction roll include a first long-diameter portion along which one non-formation portion is wound, and a second long-diameter portion along which another non-formation portion is wound. The outer diameter of the second long-diameter portion is longer than the outer diameter of the first long-diameter portion. The non-formation portion wound along the second long-diameter portion having the outer diameter longer than the outer diameter of the first long-diameter portion is stretched more than the non-formation portion wound along the first long-diameter portion. The difference in the stretched amount among the plurality of non-formation portions may be adjusted and suppressed by the difference in the stretched length among the plurality of non-formation portions caused by the difference in the outer diameter among the long-diameter portions.

A rolling method proposed herein is for rolling an electrode sheet including a band-like current collecting foil and at least one active material layer, the current collecting foil including at least two non-formation portions, the at least one active material layer and the at least two non-formation portions being located alternately in a width direction of the current collecting foil, and the at least two non-formation portions being located at both of two ends of the current collecting foil in the width direction. The method includes pressing the active material layer while transporting the electrode sheet; and stretching the non-formation portions by a correction roll while transporting the electrode sheet. The correction roll includes at least one short-diameter portion each provided at a position corresponding to the at least one active material layer in the width direction of the electrode sheet, and a plurality of long-diameter portions respectively provided at positions corresponding to the at least two non-formation portions in the width direction of the electrode sheet, the plurality of long-diameter portions each having an outer diameter longer than an outer diameter of the short-diameter portion. The plurality of long-diameter portions includes a first long-diameter portion, and a second long-diameter portion, the outer diameter of which is longer than the outer diameter of the first long-diameter portion. The stretching the non-formation portions includes winding the at least two non-formation portions respectively along the plurality of long-diameter portions and applying a tensile force to the electrode sheet.

The above-described rolling method provides substantially the same function and effect of those of the above-described rolling apparatus for the electrode sheet.

### BRIEF DESCRIPTION OF THE DRAWINGS

FIG. 1 is a schematic side view of a rolling apparatus for an electrode sheet.

FIG. 2 is a schematic front view of a guide roll.

FIG. 3 is a schematic front view of a correction roll.

FIG. 4 is a perspective view of a left attachment.

FIG. 5 is flowchart of a work of determining an outer diameter of a left long-diameter portion and an outer diameter of a right long-diameter portion.

### DETAILED DESCRIPTION

Hereinafter, a preferred embodiment of a rolling device for an electrode sheet of a power storage device will be described. The embodiment described herein is not intended to specifically limit the present invention, needless to say. The drawings show schematic views, and do not reflect any actual product embodying the present invention.

### Configuration of the Rolling Device

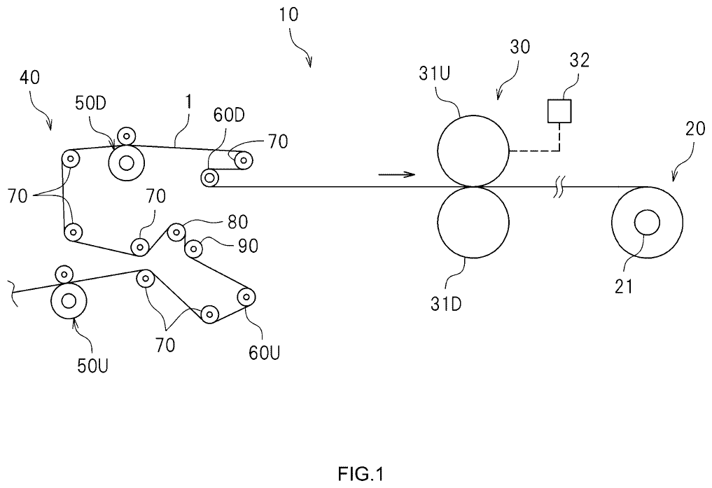

FIG. 1 is a schematic side view of a rolling apparatus 10, for an electrode sheet, according to a preferred embodiment. In this embodiment, the rolling apparatus 10 rolls an electrode sheet 1 of a lithium ion secondary battery. It should be noted that the electrode sheet 1 is not limited to being an electrode sheet of a lithium ion secondary battery, and may be an electrode sheet of any of various other known power storage devices. A “power storage device” is a term referring to devices, in general, that are capable of extracting electrical energy, and encompasses so-called storage batteries (chemical batteries) such as lithium ion secondary batteries, nickel hydrogen batteries and the like, and also capacitors (physical batteries) such as electric double layer capacitors and the like.

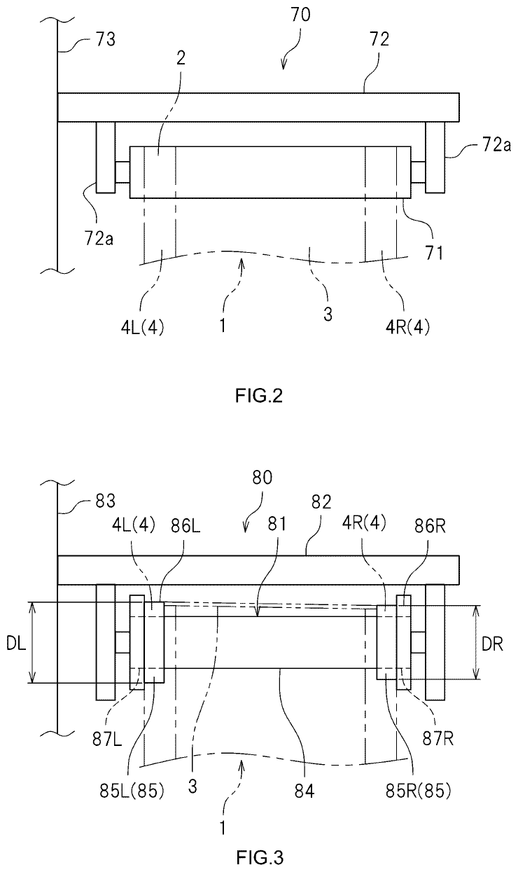

The electrode sheet 1 includes a band-like current collecting foil 2 and an active material layer 3 formed on the current collecting foil 2 (see FIG. 2). Portions, of the current collecting foil 2, on which the active material layer 3 is not formed act as non-formation portions 4. A positive electrode sheet includes the band-like current collecting foil 2 having a predefined width and a predefined thickness (e.g., an aluminum foil) and the positive active material layer 3, containing a positive electrode active material, formed on a surface of the current collecting foil 2. In, for example, a lithium ion secondary battery, the positive electrode active material is a material capable of releasing lithium ions when being charged and absorbing lithium ions when being discharged, like a lithium transition metal composite material. In the positive electrode sheet, the active material layer 3 and the non-formation portions 4 are protected by a protective layer. A negative electrode sheet includes the band-like current collecting foil 2 having a predefined width and a predefined thickness (e.g., a copper foil) and the negative active material layer 3, containing a negative electrode active material, formed on a surface of the current collecting foil 2. In, for example, a lithium ion secondary battery, the negative electrode active material is a material capable of, when being charged, occluding lithium ions and, when being discharged, releasing lithium ions occluded when being charged, like natural graphite. Various materials other than those mentioned above have been proposed as the positive electrode active material and the negative electrode active material, and there is no specific limitation thereon.

A material of the active material layer 3 is formed into a slurry and applied to the current collecting foil 2. The material of the active material layer 3 may be applied to one of two surfaces, or both of the two surfaces, of the current collecting foil 2. In the electrode sheet 1, at least one active material layer 3 and at least two non-formation portions 4 are located alternately in a width direction of the current collecting foil 2. At both of two ends of the electrode sheet 1 in the width direction, the non-formation portions 4 are located. In the electrode sheet 1 in this embodiment, the active material layer 3 is formed at a central portion in the width direction of the current collecting foil 2, and the non-formation portions 4 are formed at both of the two ends thereof (hereinafter, the non-formation portion 4 on the left in FIG. 2 will be represented as “4L”, and the non-formation portion 4 on the right in FIG. 2 will be represented as “4R” for the sake of convenience). It should be noted that a plurality of the active material layers 3 may be formed in the width direction of the electrode sheet 1. In this case, a plurality of the non-formation portions 4 are formed at both of the two ends of the electrode sheet 1 and also between the plurality of active material layers 3. The rolling apparatus 10 continuously presses the electrode sheet 1 while transporting the electrode sheet 1 in a longitudinal direction thereof to adjust the active material layer 3 such that the active material layer 3 has a thickness in a predetermined range and to increase a density of the active material in the active material layer 3.

As shown in FIG. 1, the rolling apparatus 10 includes a transportation device 20 transporting the electrode sheet 1, a roll press 30 pressing the electrode sheet 1, and a warp correction device 40 suppressing the warp or the strain of the electrode sheet 1 caused by the press. The rolling apparatus 10 may further include an inspection device or the like, but such a device will not be described or shown.

The transportation device 20 transports the electrode sheet 1 in a longitudinal direction thereof along a predefined transportation path. In this embodiment, the transportation device 20 includes a winding device 21 located at a most downstream position in the rolling apparatus 10 and winding the post-rolling electrode sheet 1. The band-like electrode sheet 1 is wound around the winding device 21, and thus a portion thereof upstream with respect to the winding device 21 is transported in the longitudinal direction.

The roll press 30 includes a pair of press rolls 31U and 31D sandwiching, and thus pressing, the electrode sheet 1, and a driving device 32 driving the pair of press rolls 31U and 31D. The pair of press rolls 31U and 31D are located on the transportation path along which the electrode sheet 1 is transported by the transportation device 20, and sandwich the electrode sheet 1 to press the active material layer 3.

The warp correction device 40 is provided upstream with respect to the roll press 30 in the transportation path of the electrode sheet 1. Alternatively, the warp correction device 40 may be provided downstream with respect to the roll press 30 in the transportation path of the electrode sheet 1. As shown in FIG. 1, the warp correction device 40 includes upstream-side and downstream-side nip rolls 50U and 50D, upstream-side and downstream-side dancer calls 60U and 60D, a plurality of guide rolls 70, a correction roll 80, and a wrap angle adjustment roll 90. When the active material layer 3 is pressed by the press rolls 31U and 31D, a portion of the current collecting foil 2 on which the active material layer 3 is formed is stretched, whereas the non-formation portions 4 are not stretched almost at all. Therefore, a difference is caused in the stretched length between the portion of the current collecting foil 2 on which the active material layer 3 is formed and the non-formation portions 4. This causes the electrode sheet 1 to be strained or warped. The warp correction device 40 stretches the non-formation portions 4 before the electrode sheet 1 is pressed, and thus suppresses the strain or the warp of the electrode sheet 1.

The upstream-side and downstream-side nip rolls 50U and 50D define a zone where a high tensile force is applied to the electrode sheet 1. A high tensile force is applied to the electrode sheet 1 between the upstream-side nip roll 50U and the downstream-side nip roll 50D. Upstream with respect to the upstream-side nip roll 50U and downstream with respect to the downstream-side nip roll 50D, the tensile force to be applied to the electrode sheet 1 may be adjusted to be weaker than the tensile force applied in the above-described zone. In the zone between the upstream-side nip roll 50U and the downstream-side nip roll 50D, the tensile force is applied to the electrode sheet 1 by the upstream-side dancer roll 60U located in this zone. The downstream-side dancer roll 60D adjusts the tensile force to be applied to the electrode sheet 1 downstream with respect to the zone. The non-formation portions 4 of the electrode sheet 1 are stretched by the tensile force applied thereto in the zone between the upstream-side nip roll 50U and the downstream-side nip roll 50D.

The plurality of guide rolls 70 causes a transportation direction of the electrode sheet 1 to make turns. The transportation path of the electrode sheet 1 is caused to make a plurality of turns by the electrode sheet 1 being wound along the plurality of guide rolls 70. FIG. 2 is a schematic front view of one guide roll 70. As shown in FIG. 2, the guide roll 70 includes a roll main body 71, a roll support member 72, and a support wall 73.

The roll main body 71 is cylindrical and extends in the width direction of the electrode sheet 1. The electrode sheet 1 is wound along an outer circumferential surface of the roll main body 71. The roll support member 72 supports the roll main body 71 such that the roll main body 71 is rotatable. In this embodiment, the roll support member 72 includes a pair of bearings 72a receiving both of two ends of the roll main body 71. It should be noted that the roll support member 72 is not limited to having such a configuration. The roll support member 72 may include, for example, a rotation shaft around which the roll main body 71 rotates. The roll support member 72 supports both of the two ends of the roll main body 71 in this preferred embodiment. However, the roll support member 72 may support one of the two ends of the roll main body 71.

The support wall 73 is located on one side in the width direction of the electrode sheet 1 with respect to the roll main body 71 and the roll support member 72 (in this embodiment, to the left of the roll main body 71 and the roll support member 72 in FIG. 2), and supports the roll support member 72. The roll support member 72 is supported at an end thereof on one side only by the support wall 73. The support wall 73 extends, for example, vertically. It should be noted that there is no specific limitation on the shape of the member that supports one end of the roll support member 72. The configuration in which the roll support member 72 is supported on one side is provided in response to demands that, for example, the costs of the rolling apparatus 10 should be decreased and that the work of attaching the electrode sheet 1 to the transportation path should be made easier.

However, because of such a configuration, in the case where a high tensile force is applied to the electrode sheet 1, the roll support member 72 is easily bent. An influence of the bending of the roll support member 72 will be described below.

The correction roll 80 adjusts a stretched amount by which each of the non-formation portions 4 of the electrode sheet 1 is stretched. In this embodiment, the correction roll 80 is located upstream with respect to the pair of press rolls 31U and 31D. The rolling apparatus 10 according to this preferred embodiment stretches the non-formation portion 4 by the correction roll 80 before pressing the active material layer 3. Alternatively, the correction roll 80 may be located downstream with respect to the pair of press rolls 31U and 31D. In this case, stretching the non-formation portions 4 by the correction roll 80 is performed after pressing the active material layer 3.

FIG. 3 is a schematic front view of the correction roll 80. The left side and the right side in FIG. 3 respectively match the left side and the right side in FIG. 2. As shown in FIG. 3, the correction roll 80 includes a correction roll main body 81, a roll support member 82, and a support wall 83. The roll support member 82 supports the correction roll main body 81 such that the correction roll main body 81 is rotatable. An axial direction of the correction roll main body 81 matches the width direction of the electrode sheet 1.

The roll support member 82 may have a configuration that is the same as, or different from, the configuration of the roll support member 72 of the guide roll 70. In this embodiment, the roll support member 82 supports both of left and right ends of the correction roll main body 81. The support wall 83 is located on one side in the width direction of the electrode sheet 1 with respect to the correction roll main body 81 and the roll support member 82 (in this embodiment, to the left of the correction roll main body 81 and the roll support member 82 in FIG. 3), and supports the roll support member 82. The roll support member 82 is also supported at an end thereof on one side only by the support wall 83. The correction roll main body 81 of the correction roll 80 is supported on the same side as the roll main body 71 of the guide roll 70. Hereinafter, the side of the end at which each of the correction roll 80 and the plurality of guide rolls 70 is supported (in this embodiment, the left side) will be referred to also as a “supported end side”, and the side of an end at which each of the correction roll 80 and the plurality of guide rolls 70 is not supported (in this embodiment, the right side) will be referred to also as a “free end side”. The support wall 83 may be common with, or different from, the support wall 73 of the guide roll 70.

As shown in FIG. 3, the correction roll main body 81 includes at least one short-diameter portion 84 and a plurality of long-diameter portions 85. Each of the at least one short-diameter portion 84 is provided at a corresponding position among positions corresponding to the at least one active material layer 3 in the width direction of the electrode sheet 1. The at least two non-formation portions 4 are respectively wound around the plurality of long-diameter portions 85. The plurality of long-diameter portions 85 each have an outer diameter longer than an outer diameter of the short-diameter portion 84. The plurality of long-diameter portions 85 are respectively provided at positions corresponding to the plurality of non-formation portions 4 in the width direction of the electrode sheet 1. The plurality of long-diameter portions 85 stretch the plurality of non-formation portions 4 wound therealong. The short-diameter portion 84 is retracted to a position inner in a diametrical direction of the correction roll main body 81 so as to avoid the active material layer 3. With such a configuration of the short-diameter portion 84 and the plurality of long-diameter portions 85, the non-formation portions 4 is stretched whereas the portion of the current collecting foil 2 having the active material layer 3 formed thereon is not stretched.

As shown in FIG. 3, in this preferred embodiment, the short-diameter portion 84 is provided in a central portion in the axial direction of the correction roll main body 81 (width direction of the electrode sheet 1), more specifically, provided at a position corresponding to the active material layer 3. In this embodiment, there is one short-diameter portion 84. The plurality of long-diameter portions 85 are located to the left of, and to the right of, the short-diameter portion 84. In this preferred embodiment, there are two long-diameter portions 85. It should be noted that the numbers of the short-diameter portion(s) 84 and the long-diameter portions 85 vary in accordance with the numbers of the active material layer(s) 3 and the non-formation portions 4 aligned in the width direction of the electrode sheet 1. Hereinafter, in the case where the two long-diameter portions 85 are to be distinguished from each other, the long-diameter portion 85 on the left side (on the supported end side) will be referred to also as a “left long-diameter portion 85L”, and the long-diameter portion 85 on the right side (on the free end side) will be referred to also as a “right long-diameter portion 85R”. The left long-diameter portion 85L is connected with a left end of the short-diameter portion 84. The right long-diameter portion 85R is connected with a right end of the short-diameter portion 84.

In a state where the non-formation portions 4 of the electrode sheet 1 are wound along the long-diameter portions 85, the short-diameter portion 84 faces the active material layer 3 and is separated from the active material layer 3.

The diameter of each of the left long-diameter portion 85L and the right long-diameter portion 85R is longer than the diameter of the short-diameter portion 84 by about 1 mm to 2 mm. An outer diameter DL of the left long-diameter portion 85L and an outer diameter DR of the right long-diameter portion 85R are different from each other. In this preferred embodiment, the outer diameter DL of the left long-diameter portion 85L on the supported end side is longer than the outer diameter DR of the right long-diameter portion 85R on the free end side. The diameter DL of the left long-diameter portion 85L and the outer diameter DR of the right long-diameter portion 85R are different from each other by, for example, about 0.05 mm to 0.1 mm. It should be noted that the difference between the outer diameter DL of the left long-diameter portion 85L and the outer diameter

DR of the right long-diameter portion 85R is defined based on actually measured values of stretched amounts of the left and right non-formation portions 4 as described below, and is not specifically limited to any value. Depending on the actually measured values of stretched amounts of the left and right non-formation portions 4, the outer diameter DR of the right long-diameter portion 85R on the free end side may be longer than the outer diameter DL of the left long-diameter portion 85L on the supported end side.

The left long-diameter portion 85L and the right long-diameter portion 85R respectively contact the left and right non-formation portions 4L and 4R at positions outer to left and right ends of the active material layer 3 by a predefined distance. For example, the left long-diameter portion 85L and the right long-diameter portion 85R are respectively provided such that inner edges thereof contact central portions or areas slightly inner to the central portions of the non-formation portions 4L and 4R in a left-right direction thereof. With this configuration, the non-formation portions 4L and 4R (in the case of the positive electrode sheet, the non-formation portions 4 and the protective layer) are stretched, whereas the active material layer 3 is prevented from being stretched along with the non-formation portions 4L and 4R. It should be noted that the positions at which the left long-diameter portion 85L and the right long-diameter portion 85R contact the non-formation portions 4L and 4R are not limited to the above-mentioned positions.

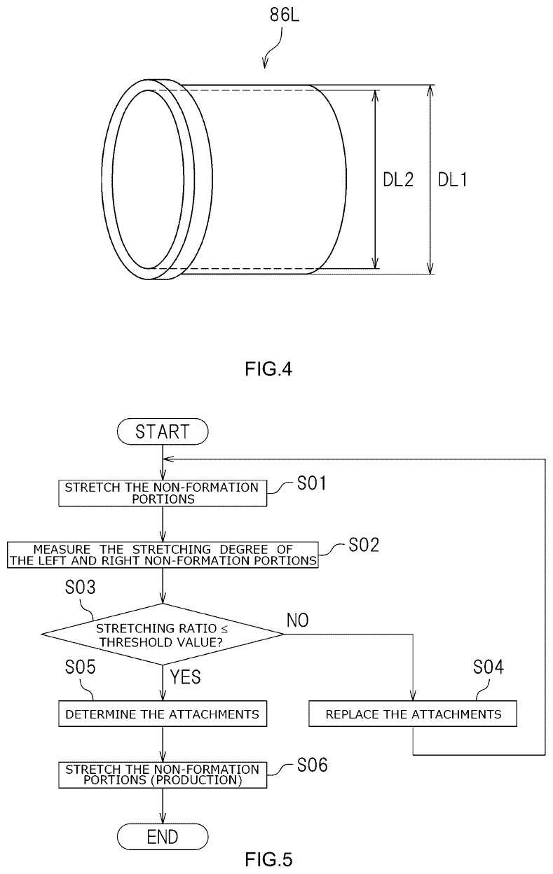

The correction roll 80 according to this preferred embodiment includes a plurality of types of left attachments 86L each forming an outer circumferential portion of the left long-diameter portion 85L. The plurality of types of left attachments 86L have different outer diameters from each other. The correction roll 80 includes a left attached portion 87L, to which either one of the plurality of types of left attachments 86L is attached. FIG. 4 is a perspective view of one left attachment 86L. As shown in FIG. 4, the left attachment 86L is cylindrical. An outer diameter DL1 of the left attachment 86L has a length varying in accordance with the type of the left attachment 86L. The outer diameter DL1 of the selected left attachment 86L is the outer diameter DL of the left long-diameter portion 85L. An inner diameter DL2 of the left attachment 86L is the same regardless of the type of the left attachment 86L, and is equal to an outer diameter of the left attached portion 87L.

Like in the case of the left long-diameter portion 85L, the correction roll 80 includes a plurality of types of right attachments 86R each forming an outer circumferential portion of the right long-diameter portion 85R. The plurality of types of right attachments 86R have different outer diameters from each other. The correction roll 80 includes a right attached portion 87R, to which either one of the plurality of types of right attachments 86R is attached. The right attachments 86R and the right attached portion 87R have substantially the same configurations as those of the left attachments 86L and the left attached portion 87L.

In this preferred embodiment, the correction roll 80 includes the plurality of types of left attachments 86L and the plurality of types of right attachments 86R respectively forming the outer circumferential portions of the left long-diameter portion 85L and the right long-diameter portion 85R and having different outer diameters from each other. Alternatively, the correction roll 80 may include only the plurality of types of left attachments 86L each forming the outer circumferential portion of the left long-diameter portion 85L and having different outer diameters from each other, or only the plurality of types of right attachments 86R each forming the outer circumferential portion of the right long-diameter portion 85R and having different outer diameters from each other. In this case, the outer diameter of the right long-diameter portion 85R or the left long-diameter portion 85L may be unchangeable. The difference between the outer diameter DL of the left long-diameter portion 85L and the outer diameter DR of the right long-diameter portion 85R is adjustable by changing the outer diameter of only one of long-diameter portions 85.

The wrap angle adjustment roll 90 adjusts a wrap angle at which the electrode sheet 1 is wound along the correction roll 80. The wrap angle adjustment roll 90 is provided adjacent to the correction roll 80 so as to adjust the wrap angle of the correction roll 80, and is movable in a direction perpendicular to the axial direction thereof.

### Reason why the Outer Diameters of the Left and Right Long-Diameter Portions are Made Different From Each Other

Hereinafter, a reason why the outer diameter DL of the left long-diameter portion 85L and the outer diameter DR of the right long-diameter portion 85R are made different from each other will be described. As described above, in the rolling apparatus 10 according to this preferred embodiment, the plurality of guide rolls 70 are supported on one side thereof. Therefore, when a high tensile force is applied to the electrode sheet 1, the free end side of each guide roll 70 is bent by the tensile force, whereas the supported end side of each guide roll 70 is not much bent. As a result, the transportation path of the electrode sheet 1 is made longer on the free end side, and thus the non-formation portion 4R on the free end side is stretched more than the non-formation portion 4L on the supported end side. The correction roll 80 makes the outer diameter DL of the left long-diameter portion 85L and the outer diameter DR of the right long-diameter portion 85R different from each other to absorb the difference in the stretched amount between the non-formation portion 4R on the free end side and the non-formation portion 4L on the supported end side.

In this preferred embodiment, the outer diameter DL of the left long-diameter portion 85L on the supported end side is longer than the diameter DR of the right long-diameter portion 85R on the free end side. Therefore, the non-formation portion 4L on the supported end side, which is wound along the left long-diameter portion 85L, is stretched, by the correction roll 80, to be longer than the non-formation portion 4R on the free end side, which is wound along the right long-diameter portion 85R. As a result, the difference, in the stretched amount between the non-formation portion 4R on the free end side and the non-formation portion 4L on the supported end side, caused by the configuration in which the roll support member 72 of the guide roll 70 is supported on one side thereof is decreased.

Table 1 shows the difference in the stretching ratio between the left and right non-formation portions 4L and 4R in the case where the outer diameter DL of the left long-diameter portion 85L and the outer diameter DR of the right long-diameter portion 85R are different from each other (example), and the difference in the stretching ratio between the left and right non-formation portions 4L and 4R in the case where the outer diameter DL of the left long-diameter portion 85L and the outer diameter DR of the right long-diameter portion 85R are equal to each other (comparative example). As shown in Table 1, the difference in the stretching ratio between the left and right non-formation portions 4L and 4R is smaller in the example than in the comparative example.

TABLE 1

| | DIFFERENCE BETWEEN | |
|---|---|---|
| | THE OUTER DIAMETERS | STRETCHING |
| | OF LONG-DIAMETER | RATIO |
| | PORTIONS (mm) | (%) |
| EXAMPLE | 0.08 | 6 |
| COMPARATIVE | 0 | 9 |
| EXAMPLE | | |

A difference in the stretching ratio between the left and right non-formation portions 4L and 4R is caused also by another factor such as the state of the electrode sheet 1 or the like. For example, there may be a case where even if the roll support member 72 of each guide roll 70, the roll support member 82 of the correction roll 80 and all the other rolls are supported on both of the two sides thereof, instead of on one side, a difference in the stretching ratio between the left and right non-formation portions 4L and 4R may be caused. In the case where, for example, the current collecting foil 2 has a difference in the thickness between a left portion and a right portion thereof from the start, the stretching ratio may possibly be different between the left and right non-formation portions 4L and 4R even if an equal tensile force is applied to the left and right non-formation portions 4L and 4R. Therefore, which of the two (or three or more) long-diameter portions 85 of the correction roll 80 is to have a longer diameter or a shorter diameter may vary and is not fixed.

### Process of Stretching the non-Formation Portions

In this preferred embodiment, the stretched amounts of the plurality of non-formation portions 4 are measured in advance, and the outer diameter DL of the left long-diameter portion 85L and the outer diameter DR of the right long-diameter portion 85R are determined based on the measured stretched amounts. Then, the non-formation portions 4 of the electrode sheet 1 are actually stretched under the determined conditions. Hereinafter, an example of procedure thereof will be described.

FIG. 5 is a flowchart of a process of determining the outer diameter DL of the left long-diameter portion 85L and the outer diameter DR of the right long-diameter portion 85R and stretching the at least two non-formation portions 4. As shown in FIG. 5, the process of stretching the non-formation portions 4 includes steps S01 through S05 of determining the outer diameter DL of the left long-diameter portion 85L and the outer diameter DR of the right long-diameter portion 85R. The process of stretching the non-formation portions 4 further includes step S06 of winding the at least two non-formation portions 4 respectively along the plurality of long-diameter portions 85 and applying a tensile force to the electrode sheet 1.

As shown in FIG. 5, in step S01 of the process of determining the outer diameter DL of the left long-diameter portion 85L and the outer diameter DR of the right long-diameter portion 85R, the left and right non-formation portions 4L and 4R of an end or the like of the electrode sheet 1 in the longitudinal direction is stretched actually. In step S01, the electrode sheet 1 is caused to pass between the pair of upstream-side nip rolls 50U, is wound along the other rolls of the warp correction device 40, and is caused to pass between the pair of downstream-side nip rolls 50D. Then, the rolls in the warp correction device 40 are driven, and a tensile force is applied to the electrode sheet 1 by the dancer rolls 60U and 60D. As a result, the electrode sheet 1 is transported along the transportation path, and the left and right non-formation portions 4L and 4R are stretched.

Next in step S02, the stretched length of the non-formation portion 4L caused by the left long-diameter portion 85L and the stretched length of the non-formation portion 4R caused by the right long-diameter portion 85R are measured. In step S03, a difference between the stretching ratio of the non-formation portion 4L and the stretching ratio of the non-formation portion 4R is found, and it is determined whether or not the found difference between the stretching ratios is no more than a predefined threshold value. In the case where the difference between the stretching ratios is no more than a predefined threshold value (YES in step S03), it is determined in step S05 that the left attachment 86L and the right attachment 86R are used as they are with no replacement. In the case where the difference between the stretching ratios exceeds the predefined threshold value (NO in step S03), in step S04, the outer diameter of at least one of the left long-diameter portion 85L and the right long-diameter portion 85R is adjusted based on the measured stretched lengths of the non-formation portions 4L and 4R. In step S04, at least one of the left attachment 86L and the right attachment 86R is replaced so as to absorb the difference in the stretching ratio found in step S03. In step S04, either one of the plurality of left attachments 86L or either one of the plurality of right attachment 86R is selected and attached to the correction roll 80.

After step S04, steps S01 through S03 are performed again.

When the determination result of step S03 becomes YES by the repetition of steps S01 through S04, in step S05, the left attachment 86L and the right attachment 86R to be used are determined. Step S06 of stretching the non-formation portions 4 as a step of production of the electrode sheet 1 after the adjustment is substantially the same as step S01.

### Functions and Effects of the Embodiment

Hereinafter, functions and effects provided by the rolling apparatus 10 for the electrode sheet 1 and a process using the rolling apparatus 10 according to this preferred embodiment will be described.

The rolling apparatus 10 for the electrode sheet 1 according to this preferred embodiment rolls the electrode sheet 1 including the band-like current collecting foil 2 and at least one active material layer 3. The electrode sheet 1 includes at least two non-formation portions 4. The at least one active material layer 3 and the at least two non-formation portions 4 are located alternately in the width direction of the current collecting foil 2. The at least two non-formation portions 4 are located at both of the two ends of the current collecting foil 2 in the width direction. The rolling apparatus 10 includes the transportation device 20 transporting the electrode sheet 1 in the longitudinal direction thereof along the predefined transportation path; the pair of press rolls 31U and 31D located on the transportation path along which the electrode sheet 1 is transported by the transportation device 20 and sandwiching the electrode sheet 1 to press the active material layer 3; and the correction roll 80 located upstream with respect to the pair of press rolls 31U and 31D in the transportation path and extending in the width direction of the electrode sheet 1. The correction roll 80 includes at least one short-diameter portion 84 each provided at a position corresponding to the at least one active material layer 3 in the width direction of the electrode sheet 1, and a plurality of long-diameter portions 85 each having an outer diameter longer than an outer diameter of the short-diameter portion 84. The at least two non-formation portions 4 are respectively wound along the plurality of long-diameter portions 85. The plurality of long-diameter portions 85 include a first long-diameter portion, and a second long-diameter portion. The outer diameter of the second long-diameter portion is longer than the outer diameter of the first long-diameter portion. In this preferred embodiment, the first long-diameter portion is the right long-diameter portion 85R, and the second long-diameter portion is the left long-diameter portion 85L.

With the rolling apparatus 10 having such a configuration, the non-formation portion 4L wound along the second long-diameter portion (in this embodiment, the left long-diameter portion 85L) having the outer diameter longer than the outer diameter of the first long-diameter portion (in this embodiment, the right long-diameter portion 85R) is stretched more than the non-formation portion 4R wound along the first long-diameter portion 85R. As described above, the stretched amounts of the plurality of non-formation portions 4 may vary in accordance with the configuration of the rolling apparatus 10, the state of the electrode sheet 1 or the like. With the rolling apparatus 10 according to this preferred embodiment, the above-described difference in the stretched amount among the plurality of non-formation portions 4 may be adjusted by the difference in the stretched length among the plurality of non-formation portions 4 caused by the difference in the outer diameter among the long-diameter portions 85. As a result, the difference in the stretched amount among the plurality of non-formation portions 4 may be suppressed.

In this preferred embodiment, the correction roll 80 is located upstream with respect to the pair of press rolls 31U and 31D. This configuration may decrease an undesirable possibility that the electrode sheet 1 is broken in the step of pressing the active material layer 3. It is possible to locate the correction roll 80 downstream with respect to the pair of press rolls 31U and 31D. However, it is preferred that the non-formation portions 4 are stretched before the step of pressing the active material layer 3. A reason for this is that this arrangement decreases an undesirable possibility that the non-formation portions 4 cannot follow the stretching of the active material layer 3 in the pressing step and as a result, the electrode sheet 1 is broken. The rolling apparatus 10 may include another correction roll located downstream with respect to the pair of press rolls 31U and 31D in the transportation path, so that the warp of the electrode sheet 1 may be corrected before and after the pressing step.

The rolling apparatus 10 according to this preferred embodiment further includes the guide roll 70 located upstream or downstream with respect to the correction roll 80 in the transportation path. The electrode sheet 1 is wound along the guide roll 70. The guide roll 70 includes the roll main body 71 extending in the width direction of the electrode sheet 1, the roll support member 72 supporting the roll main body 71 such that the roll main body 71 is rotatable, and the support wall 73 located on one of two sides in the width direction with respect to the roll main body 71 and the roll support member 72 (in this embodiment, located to the left of the roll main body 71 and the roll support member 72), the support wall 73 supporting the roll support member 72. The roll support member 72 is supported at only one of two ends thereof by the support wall 73. The second long-diameter portion having the longer outer diameter (in this embodiment, the left long-diameter portion 85L) is located on the one side in the width direction of the electrode sheet 1 (i.e., on the left side, and on the support end side) with respect to the first long-diameter portion having the shorter outer diameter (in this embodiment, the right long-diameter portion 85R).

As described above, the roll main body 71 of the guide roll 70 is supported on one side, more specifically, on the support end side, so that the non-formation portion 4R on the free end side is stretched by the guide roll 70 to be longer than the non-formation portion 4L on the supported end side. In the meantime, with the above-described configuration of the correction roll 80, the non-formation portion 4L on the support end side, which is wound along the left long-diameter portion 85L having the longer outer diameter is stretched by the correction roll 80 to be longer than the non-formation portion 4R on the free end side, which is wound along the right long-diameter portion 85R. Therefore, the non-formation portions 4 are wound along the correction roll 80, so that the difference, in the stretched amount between the non-formation portions 4 on the free end side and on the supported end side, caused by the configuration in which the roll support member 72 of the guide roll 70 is supported on one side is decreased.

In this preferred embodiment, the outer diameter of each of the left long-diameter portion 85L and the right long-diameter portion 85R is adjustable. With this configuration, the difference between the outer diameter DL of the left long-diameter portion 85L and the outer diameter DR of the right long-diameter portion 85R may be adjusted in accordance with which one of the left non-formation portion 4L and the right non-formation portion 4R is stretched more than the other non-formation portion 4 and how much such one non-formation portion 4 is stretched more than the other non-formation portion 4. In this manner, the difference in the stretched length between the left non-formation portion 4L and the right non-formation portion 4R may be further suppressed. As long as the outer diameter of at least one of the left long-diameter portion 85L and the right long-diameter portion 85R is adjustable, substantially the same function and effect are provided.

In this preferred embodiment, the correction roll 80 includes the plurality of types of left attachments 86L forming the outer circumferential portion of the left long-diameter portion 85L and having different outer diameters from each other, and the plurality of types of right attachments 86R forming the outer circumferential portion of the right long-diameter portion 85R and having different outer diameters from each other. The correction roll 80 includes the left attached portion 87L, to which either one of the plurality of types of left attachments 86L is attached, and the right attached portion 87R, to which either one of the plurality of types of right attachments 86R is attached. With this configuration, the work of replacing the attachments 86L and 86R allows the outer diameter DL of the left long-diameter portion 85L and the outer diameter DR of the right long-diameter portion 85R to be adjusted easily.

A rolling method for rolling the electrode sheet 1 includes step S02 of measuring the stretched length of the non-formation portion 4L caused by the left long-diameter portion 85L and the stretched length of the non-formation portion 4R caused by the right long-diameter portion 85R, and step S04 of adjusting the outer diameter of at least one of the left long-diameter portion 85L and the right long-diameter portion 85R based on the measured stretched lengths of the non-formation portions 4L and 4R. With this method, it is learned, in step S02, which one of the left non-formation portion 4L and the right non-formation portion 4R is stretched more than the other non-formation portion 4 and how much such one non-formation portion 4 is stretched more than the other non-formation portion 4. In step S04, the difference between the outer diameter DL of the left long-diameter portion 85L and the outer diameter DR of the right long-diameter portion 85R may be adjusted based on the results in step S02. In this manner, the difference in the stretched length between the left non-formation portion 4L and the right non-formation portion 4R may be suppressed.

The rolling apparatus 10 according to this preferred embodiment is especially effective when rolling a positive electrode sheet including the current collecting foil 2 formed of an aluminum foil and the active material layer 3 formed of a positive electrode active material layer. For the positive electrode sheet, it is desired that the active material layer 3 should be strongly pressed to increase the density of the positive electrode active material layer. However, this tends to increase the warp or the strain of the positive electrode sheet. In general, the positive electrode active material is harder than the negative electrode active material. Therefore, a high pressure is needed to provide a desired compression ratio. This increases the stretching ratio of the active material layer 3. This inevitably increases the target value of the stretching ratio of the non-formation portions 4. Therefore, the difference in the stretched length between the left non-formation portion 4L and the right non-formation portion 4R tends to be large. For these reasons, the rolling apparatus 10 according to this preferred embodiment is especially effective when rolling a positive electrode sheet including the current collecting foil 2 formed of an aluminum foil and the active material layer 3 formed of a positive electrode active material layer.

### Other Embodiments

A preferred embodiment of the rolling apparatus for an electrode sheet proposed herein is described above. The above-described embodiment is merely an example, and the present invention may be carried out in any of various other embodiments. For example, in the above-described embodiment, the long-diameter portions are provided at both of the two ends of the correction roll main body, and the outer diameter of one of the long-diameter portions is longer than the outer diameter of the other long-diameter portion. Alternatively, the correction roll corresponding to an electrode sheet including three or more non-formation portions may include three or more long-diameter portions. The long-diameter portion having an outer diameter longer or shorter than those of the other long-diameter portions may be provided at a position other than the two ends. In the correction roll including three or more long-diameter portions, such a plurality of long-diameter portions may have three or more different outer diameters.

In the above-described embodiment, the outer diameter of the long-diameter portion is changed by selecting one attachment. The method for adjusting the outer diameter of the long-diameter portion is not limited to this. For example, the outer diameter of the long-diameter portion may be adjusted by winding a tape of the like around the outer circumferential portion of the long-diameter portion. Alternatively, the outer diameters of the plurality of long-diameter portions may be fixed and unadjustable as long as the rolling conditions are stable.

The above-described embodiments do not limit the present invention in any way unless otherwise specified. The technology disclosed herein may be altered in any of various manners. The elements and the processes referred to herein may each be omitted where appropriate, or may be combined in an appropriate manner, unless any specific problem is caused.

This specification includes the following disclosure.

### Item 1

A rolling apparatus rolling an electrode sheet including a band-like current collecting foil and at least one active material layer, the current collecting foil including at least two non-formation portions, the at least one active material layer and the at least two non-formation portions being located alternately in a width direction of the current collecting foil, and the at least two non-formation portions being located at both of two ends of the current collecting foil in the width direction, the rolling apparatus comprising:
a transportation device transporting the electrode sheet in a longitudinal direction thereof along a predefined transportation path;
a pair of press rolls located on the transportation path along which the electrode sheet is transported by the transportation device, the pair of press rolls sandwiching the electrode sheet to press the active material layer; and
a correction roll located upstream or downstream with respect to the pair of press rolls in the transportation path and extending in the width direction of the electrode sheet,
wherein:
the correction roll includes:
   at least one short-diameter portion each provided at a position corresponding to the at least one active material layer in the width direction of the electrode sheet, and
   a plurality of long-diameter portions each having an outer diameter longer than an outer diameter of the short-diameter portion, the at least two non-formation portions being respectively wound along the plurality of long-diameter portions, and
the plurality of long-diameter portions includes:
   a first long-diameter portion, and
   a second long-diameter portion, the outer diameter of which is longer than the outer diameter of the first long-diameter portion.

### Item 2

The rolling apparatus according to Item 1, wherein the correction roll is located upstream with respect to the pair of press rolls.

### Item 3

The rolling apparatus according to Item 1 or 2, further comprising a guide roll located upstream or downstream with respect to the correction roll in the transportation path, the electrode sheet being wound along the guide roll, wherein:
the guide roll includes:
   a roll main body extending in the width direction of the electrode sheet,
   a first support member supporting the roll main body such that the roll main body is rotatable, and
   a second support member located on one of two sides in the width direction with respect to the roll main body and the first support member, the second support member supporting the first support member,
the first support member is supported at only one of two ends thereof by the second support member, and
the second long-diameter portion is located on the one side in the width direction with respect to the first long-diameter portion.

### Item 4

The rolling apparatus according to any one of Items 1 through 3, wherein the outer diameter of the at least one of the first long-diameter portion and the second long-diameter portion is adjustable.

### Item 5

The rolling apparatus according to Item 4, wherein the correction roll includes:
a plurality of types of attachments forming an outer circumferential portion of at least one of the first long-diameter portion and the second long-diameter portion, the plurality of types of attachments having different outer diameters from each other, and
an attached portion to which one of the plurality of types of attachments is attached.

### Item 6

The rolling apparatus according to any one of Items 1 through 5, wherein the electrode sheet is a positive electrode sheet including the current collecting foil formed of an aluminum foil and the active material layer formed of a positive electrode active material layer.

### Item 7

A rolling method for rolling an electrode sheet including a band-like current collecting foil and at least one active material layer, the current collecting foil including at least two non-formation portions, the at least one active material layer and the at least two non-formation portions being located alternately in a width direction of the current collecting foil, and the at least two non-formation portions being located at both of two ends of the current collecting foil in the width direction, the method comprising:
pressing the active material layer while transporting the electrode sheet; and
stretching the non-formation portions by a correction roll also while transporting the electrode sheet,
wherein:
the correction roll includes:
   at least one short-diameter portion each provided at a position corresponding to the at least one active material layer in the width direction of the electrode sheet, and
   a plurality of long-diameter portions respectively provided at positions corresponding to the at least two non-formation portions in the width direction of the electrode sheet, the plurality of long-diameter portions each having an outer diameter longer than an outer diameter of the short-diameter portion,
the plurality of long-diameter portions includes a first long-diameter portion, and a second long-diameter portion, the outer diameter of which is longer than the outer diameter of the first long-diameter portion, and
the stretching the non-formation portions includes winding the at least two non-formation portions respectively along the plurality of long-diameter portions and applying a tensile force to the electrode sheet.

### Item 8

The rolling method according to Item 7, wherein the stretching the non-formation portions is performed before the pressing the active material layer.

### Item 9

The rolling method according to Item 7 or 8, further comprising:
measuring a stretched length by which one of the at least two non-formation portions is stretched by the first long-diameter portion and a stretched length by which another one of the at least two non-formation portions is stretched by the second long-diameter portion, and
adjusting the outer diameter of at least one of the first long-diameter portion and the second long-diameter portion based on the measured stretched lengths.

### Item 10

The rolling method according to Item 9, wherein the adjusting the outer diameter includes attaching, to the correction roll, one of a plurality of types of attachments each forming an outer circumferential portion of at least one of the first long-diameter portion and the second long-diameter portion, the plurality of types of attachments having different outer diameters from each other.

### Item 11

The rolling method according to any one of Items 7 through 10, wherein the electrode sheet is a positive electrode sheet including the current collecting foil formed of an aluminum foil and the active material layer formed of a positive electrode active material layer.

What is claimed is:

1. A rolling apparatus rolling an electrode sheet including a band-like current collecting foil and at least one active material layer, the current collecting foil including at least two non-formation portions, the at least one active material layer and the at least two non-formation portions being located alternately in a width direction of the current collecting foil, and the at least two non-formation portions being located at both of two ends of the current collecting foil in the width direction, the rolling apparatus comprising:
a transportation device transporting the electrode sheet in a longitudinal direction thereof along a predefined transportation path;
a pair of press rolls located on the transportation path along which the electrode sheet is transported by the transportation device, the pair of press rolls sandwiching the electrode sheet to press the active material layer; and
a correction roll located upstream or downstream with respect to the pair of press rolls in the transportation path and extending in the width direction of the electrode sheet,
wherein:
the correction roll includes:
at least one short-diameter portion each provided at a position corresponding to the at least one active material layer in the width direction of the electrode sheet, and
a plurality of long-diameter portions each having an outer diameter longer than an outer diameter of the short-diameter portion, the at least two non-formation portions being respectively wound along the plurality of long-diameter portions, and
the plurality of long-diameter portions includes:
a first long-diameter portion, and
a second long-diameter portion, the outer diameter of which is longer than the outer diameter of the first long-diameter portion.

2. The rolling apparatus according to claim 1, wherein the correction roll is located upstream with respect to the pair of press rolls.

3. The rolling apparatus according to claim 1, further comprising a guide roll located upstream or downstream with respect to the correction roll in the transportation path, the electrode sheet being wound along the guide roll, wherein:
the guide roll includes:
a roll main body extending in the width direction of the electrode sheet,
a first support member supporting the roll main body such that the roll main body is rotatable, and
a second support member located on one of two sides in the width direction with respect to the roll main body and the first support member, the second support member supporting the first support member,
the first support member is supported at only one of two ends thereof by the second support member, and
the second long-diameter portion is located on the one side in the width direction with respect to the first long-diameter portion.

4. The rolling apparatus according to claim 1, wherein the outer diameter of the at least one of the first long-diameter portion and the second long-diameter portion is adjustable.

5. The rolling apparatus according to claim 4, wherein the correction roll includes:
a plurality of types of attachments forming an outer circumferential portion of at least one of the first long-diameter portion and the second long-diameter portion, the plurality of types of attachments having different outer diameters from each other, and
an attached portion to which one of the plurality of types of attachments is attached.

6. The rolling apparatus according to claim 1, wherein the electrode sheet is a positive electrode sheet including the current collecting foil formed of an aluminum foil and the active material layer formed of a positive electrode active material layer.

7. A rolling method for rolling an electrode sheet including a band-like current collecting foil and at least one active material layer, the current collecting foil including at least two non-formation portions, the at least one active material layer and the at least two non-formation portions being located alternately in a width direction of the current collecting foil, and the at least two non-formation portions being located at both of two ends of the current collecting foil in the width direction, the method comprising:
pressing the active material layer while transporting the electrode sheet; and
stretching the non-formation portions by a correction roll also while transporting the electrode sheet,
wherein:
the correction roll includes:
at least one short-diameter portion each provided at a position corresponding to the at least one active material layer in the width direction of the electrode sheet, and
a plurality of long-diameter portions respectively provided at positions corresponding to the at least two non-formation portions in the width direction of the electrode sheet, the plurality of long-diameter portions each having an outer diameter longer than an outer diameter of the short-diameter portion,
the plurality of long-diameter portions includes a first long-diameter portion, and a second long-diameter portion, the outer diameter of which is longer than the outer diameter of the first long-diameter portion, and
the stretching the non-formation portions includes winding the at least two non-formation portions respectively along the plurality of long-diameter portions and applying a tensile force to the electrode sheet.

8. The rolling method according to claim 7, wherein the stretching the non-formation portions is performed before the pressing the active material layer.

9. The rolling method according to claim 7, further comprising:
measuring a stretched length by which one of the at least two non-formation portions is stretched by the first long-diameter portion and a stretched length by which another one of the at least two non-formation portions is stretched by the second long-diameter portion, and
adjusting the outer diameter of at least one of the first long-diameter portion and the second long-diameter portion based on the measured stretched lengths.

10. The rolling method according to claim 9, wherein the adjusting the outer diameter includes attaching, to the correction roll, one of a plurality of types of attachments each forming an outer circumferential portion of at least one of the first long-diameter portion and the second long-diameter portion, the plurality of types of attachments having different outer diameters from each other.

11. The rolling method according to claim 7, wherein the electrode sheet is a positive electrode sheet including the current collecting foil formed of an aluminum foil and the active material layer formed of a positive electrode active material layer.
